(19) United States
(12) Patent Application Publication
(10) Pub. No.: US 2018/0300395 A1
(43) Pub. Date: Oct. 18, 2018

(54) 3-STAGE CONVERSATIONAL ARGUMENT PROCESSING METHOD FOR SEARCH QUERIES

(71) Applicant: SoundHound, Inc., Santa Clara, CA (US)

(72) Inventor: Jason Weinstein, Toronto (CA)

(73) Assignee: SoundHound, Inc., Santa Clara, CA (US)

(21) Appl. No.: 15/486,073

(22) Filed: Apr. 12, 2017

(51) Int. Cl. G06F 17/30; G10L 15/18; G10L 15/22

(52) U.S. Cl. CPC G06F 17/30684; G10L 15/22; G10L 15/1822; G06F 17/30699

(57) ABSTRACT

A conversational virtual assistant searches databases using as search result filters current arguments from a user's natural language expression together with conversational arguments stored in an historical conversation state. If a search finds no results, a second search may disregard some or all arguments in order to provide a response that includes some search results. The second search can disregard all conversational arguments or just some, the choice being based on one or more criteria such as: the presence of a conversational phrasing clue; conversational arguments being projectable onto current arguments; the relative importance of argument; the age of arguments; and a specific limit to the number of arguments. Conversational virtual assistants can respond to spoken utterances and to natural language expressions and can ask users for request disambiguation.

### FIELD OF THE INVENTION

The present invention is in the field of conversational assistants that respond to a user's request for information by filtering search results based on historical conversation state.

### BACKGROUND

Electronic conversational virtual assistants are increasingly available for sale and used by consumers. Electronic conversational virtual assistants include informational and entertainment devices are increasing used in in homes, automobiles, workplace equipment, shopping and point-of-sale devices, robots, and other such devices. Some such assistants support user interactions by voice and some by typing, gesturing, thinking, or other means of human-machine interaction.

A common feature of conversational virtual assistants is an ability to search information in databases. Examples of databases that are valuable to search include retail inventory, sports statistics, geographical information, wiki knowledge base information, historical email messages, address book entries, legal statutes, and others. Many such systems allow users to specify search arguments that filter search results to return only data meeting the criteria specified by the search arguments. Some such systems allow users to specify multiple search arguments and combine the arguments to filter search results and to return only data matching attributes specified in all (combined) search arguments. Some such systems combine search arguments across multiple successive searches for use as a combined filter.

One common problem is that, when a user makes a second search request, it may be ambiguous as to whether the user does or does not want the arguments of the first search request (“conversational arguments”) to be combined with the arguments of the second search request (“current arguments”). The system must guess at the user's intent, is sometimes wrong, and thereby causes a frustrating experience for the user. When incorrectly assuming that the user wanted arguments to be combined, the system may filter too much and eliminate results that the user might have wanted. When incorrectly assuming that the user does not want arguments combined, the user may get too many results and have to start a new search request, remembering to explicitly include all arguments, even those used in previous search requests.

Another common problem is that such systems, when combining multiple arguments, filters such that it finds no results. Users, when searching, want results. The system providing no results, even for an over constrained search, gives an undesirable user experience.

### SUMMARY OF THE INVENTION

The present invention is directed to conversational virtual assistants that employ conversational search methods in selecting to use search criteria from historical context when filtering results from a user's search request to search a database of interest. The multiple strategies include automatically retrying to filter search results using a different set of filters when the previous search returns too many or too few results.

Some embodiments store a history of arguments from one or a plurality of previous search requests and use these conversational arguments in combination with the current search arguments. This history is a component of the state of the conversation between the user and the machine. Some embodiments maintain conversation state; receive search queries, including zero or more current argument values; perform a first search with the current arguments and conversational arguments combined; and if that returns no results, perform a broader second search that filters using only the current arguments. Some embodiments, if neither search provides any results, perform a third search with no arguments. A search with no arguments provides a list of all available data, i.e. all records in a database. This ensures that the search provides some result if the database has any data at all. Some embodiments, in response to the second search providing no results, ask the user to disambiguate the search by specifying different arguments. Some embodiments choose whether to include conversational arguments based on a current reference to a previous search request or search results referred to herein as a conversational phrasing clue. Some embodiments check conversational arguments and include them in the search only if they are projectable onto the current search arguments. A conversational argument is projectable onto a current argument if a search for the current argument can be extended to a meaningful search for the current argument and the conversational argument. Some embodiments, in order to broaden searches to find results, use some but disregard other ones of multiple conversational arguments. Various such embodiments do so based on the relative importance of argument, based on the recency in which the user provided conversational arguments, or whether conversational arguments have expired and lost their meaning. In some embodiments, some arguments are more important than others. For example, in a search for houses, price is more important than color. In a search for computers, processor speed is more important than the number of universal serial bus (USB) ports. Some embodiments limit the number of conversational arguments to a maximum number. Some such embodiments perform multiple successive searches with different combinations of conversational arguments within the limit of the maximum number, such as 1 or 2. Some embodiments interact with users using natural language parsing. Some embodiments interact with users using spoken utterances recognized by automatic speech recognition (ASR).

Conversational assistants provided by embodiments of the invention described herein are associated with a domain and a database whose records are relevant in the domain. A person of skill in the art can envision a conversational assistant using multiple domains and associated databases in which the user's conversation state and current search requests select the most relevant domain and search a database corresponding to the selected domain.

As used herein, the term “database” does not necessarily imply any unity of structure. For example, two or more separate databases, when considered together, still constitute a “database” as that term is used herein. A database can be provided by relational database management systems (RDBMSs), object oriented database management systems (OODBMSs), distributed file systems (DFS), no-schema database, or any other data storing systems or computing devices.

### BRIEF DESCRIPTION OF THE DRAWINGS

FIG. 1 illustrates a flowchart of a 3-stage search method, according to an embodiment of the invention.

FIG. 2 illustrates a dialog between a user and a system according to an embodiment of the invention.

FIG. 3 illustrates a dialog between a user and a system according to an embodiment of the invention.

FIG. 4 illustrates a flowchart of another 3-stage search method, according to an embodiment of the invention.

FIG. 5 illustrates a dialog with system behavior according to an embodiment of the invention.

FIG. 6 illustrates a dialog between a user and a system that maintains a conversation state and uses conversational arguments across multiple entries of history, according to an embodiment of the invention.

FIG. 7 illustrates a flowchart of a method determining which arguments to use in a search query based on detecting the presence of a conversational phrasing clue, according to an embodiment of the invention.

FIG. 8A and FIG. 8B each illustrates a dialog between a user and a system that uses conversational phrasing clues to determine which arguments to use to filter a search request according to an embodiment of the invention.

FIG. 9 illustrates a flowchart of a method for selecting which conversational arguments to combine for filtering a search request, according to an embodiment of the invention.

FIG. 10 illustrates a dialog between a user and a system that selects conversational arguments for inclusion in a search filter based on whether each is projectable onto all current arguments, according to an embodiment of the invention.

FIG. 11 illustrates a dialog between a user and a system that automatically broadens its search by discarding arguments in order to provide a non-empty set of results, according to an embodiment of the invention.

FIG. 12 illustrates a dialog between a user and a system that responds to a user's search request by trying different combinations of arguments, according to an embodiment of the invention.

FIG. 13 illustrates a dialog between a user and a mobile phone according to an embodiment of the invention.

FIG. 14A shows a Flash random access memory (RAM).

FIG. 14B shows the solder-ball side of a system-on-chip package.

FIG. 14C shows the top side of the system-on-chip package.

FIG. 15 illustrates a data center server system, according to an embodiment of the invention.

FIG. 16 illustrates a block diagram of a system-on-chip, according to an embodiment of the invention.

FIG. 17 illustrates a block diagram of a server system, according to an embodiment of the invention.

### DETAILED DESCRIPTION

### Terminology

The present invention pertains to searching electronic sources of information. Various embodiments are applicable to various information sources such as records in databases and web sites. Various embodiments are applicable to different types of search entry such as plain text searches, keyword searches, and natural language searches. Various embodiments are applicable to different search algorithms such as linear searches and binary searches.

Searches are functions that return results, information obtained from performing a search request. A search request is a request, initiated by a user, for a system to find information in a database. In various embodiments, results include any number of pieces of information. In various embodiments, results are links to web pages, geolocations, products for purchase, information about people, and various types of information.

Search functions accept arguments that constrain which results are returned. Different systems may receive arguments from users in different ways. For example, in an embodiment, a system may require the user to specify both the argument and the its value in the search request, (e.g. “show me cars whose color is red”). The examples provided herein are for a system in which the user is only required to specify an argument value (e.g. “show me red cars”), and the system determines the argument to which the value corresponds. Thus the system determines the search's current arguments based on the value specified in the search request.

A user's search request may include zero or more argument values from which corresponding current arguments may be determined. Such arguments act as filters and comprise attribute/value pairs. Filters constrain results to only those database records having a field (e.g. color) matching the argument in which the value of the field matches the argument value (e.g. red). There are a variety of ways that a system can determine the appropriate argument from a value that is included a search request. Some embodiments rely on system designers to specify legal values of arguments. Such embodiments, upon finding an argument value in a search request, determine which argument for which the value is a legal one, and assign the value to the that argument for the search. The search disregards any arguments that has no specified value, and thereby does not filter on that argument.

Some embodiments allow multiple arguments to have the same argument value. For example, a car can have a transmission argument with value automatic and a windows argument with value automatic. Such embodiments require that natural language grammar rules disambiguate between which argument is assigned the value when it appears in a search request. For example, “automatic windows” or “windows that are automatic” indicate that the value automatic applies to the windows argument, where as simply referring to a car as “an automatic” indicates that the value automatic applies to the transmission.

Some embodiments maintain a conversation state. Conversation state is a stored array of meta information about previous searches including search arguments of previous searches, which are also called conversational arguments. Various embodiments store conversation state for one or more than one search request. Some embodiments add information from search requests to the conversation state as part of processing each search request. Some embodiments discard conversational arguments after a certain number of following search requests. Some embodiments discard conversational arguments after a certain amount of time. Conversation state allows a system to provide a more natural user experience, approximating what is in a user's mind at any moment by using topical information from recent search requests.

Various embodiments in various scenarios use conversational arguments in addition to current arguments, specified in the current search request, to perform filtered searches. Some embodiments use conversational arguments only if the search request includes a conversational phrasing clue. Some conversational phrasing clues are words such as, “how about”, “what about”, and referential pronouns such as “ones”, “which”, and “their”. For example, following a first search for cars, a second search has a conversational phrasing clue if it is, “how about red ones” or “which of them are red”.

A domain of conversation represents a subject area, and comprises a set of grammar rules and vocabulary that is recognized within the domain. A user's search request is interpreted within a domain that is associated with the database being queried.

A conversational argument is projectable onto a current argument if a search for the current argument can be extended to a meaningful search for the current argument and the conversational argument. The authors of parsing rules indicate which arguments are projectable onto one another based on the attributes of the objects within their data domain. For example, “color” is projectable onto “transmission type” because both are attributes of a car. Transmission type is not projectable onto flavor because there is no meaningful class of object for which transmission and flavor are attributes.

In general, arguments that apply to a single domain are projectable if they are of different types and not projectabable if they are the same type. There are exceptions, however, and the projectability can depend also on argument values, not just argument types. Assuming all cars are solid colors, you could still have cases where multiple color arguments are projectable—for example “metallic” and “blue.” Also, sometimes arguments of different types can be non-projectable. For example “electric” and (“with at least a 15 gallon fuel tank” or “that gets at least 20 miles per gallon”) would be considered different argument types in most implementations, but are not projectable.

Domain-specific rules used by the system to translate a user's search request into a corresponding search query specify the attributes recognized for an object in the domain. Thus, determining projectablility involves finding a domain in which the conversational argument and the current argument are both recognized and can be used to describe the same object.

Some embodiments use simple searching methods, such as by detecting and considering keywords. Some embodiments accept search requests as natural language expressions and parse them using a natural language interpreter to find the subjects, objects, and modifier attributes and their values that a user intends as search arguments. In various embodiments, natural language interpretation includes identifying n-grams, synonyms, and colloquialisms.

Some embodiments operate on textual search requests. Some embodiments operate on spoken speech search requests, such as by converting the speech to textual arguments using ASR. Various other input methods and formats are possible.

Some embodiments perform functions other than search. Such embodiments accept other forms of commands, such as ones requesting an action. For example, some embodiment can prepare a message to people in a club, people (including guests) who attended the most recent club meeting, neither, or both. Some embodiments store information in conversation state other than arguments determined from a search request.

### Embodiments

Various embodiments of the present invention are, machines, systems, methods by which they operate, methods by which they are operated, computer systems, and non-transitory computer readable media storing code that, when executed, causes one or more computers to perform methods and operations according to the invention.

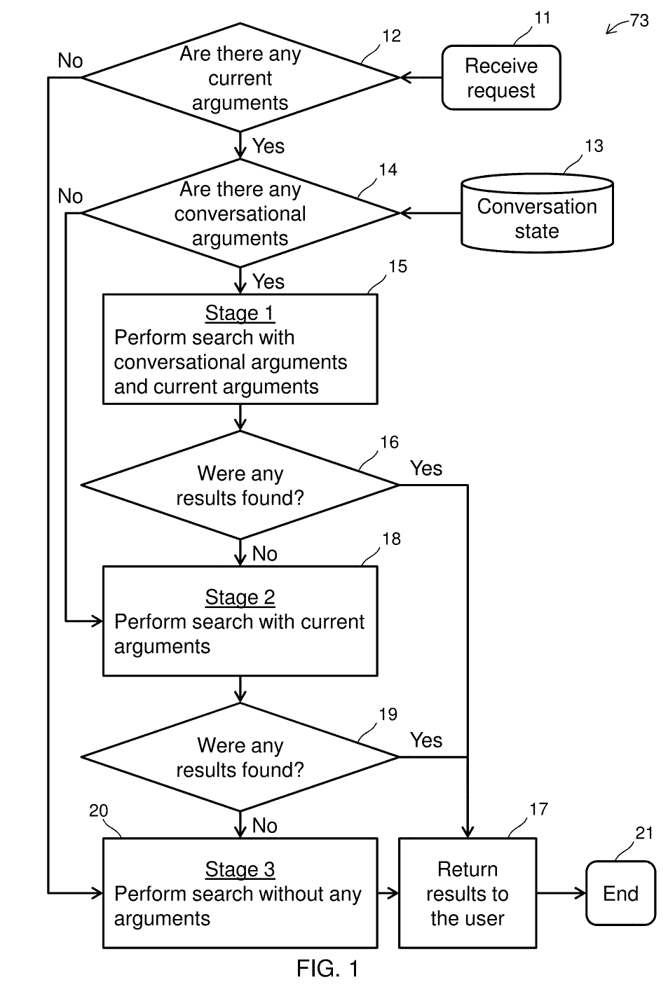

FIG. 1 shows a 3-stage search method, according to an embodiment of the invention. The method 73 begins when the system receives a search request 11. Next, the system checks to see if the search request has any values from which to derive current arguments in step 12. (Hereinafter, the phrase “search request having/including/specifying current arguments” is used as a shorthand way to express “search request having including/specifying values of current arguments.”) For each value appearing in the search request, the system creates a current argument by determining the attribute corresponding to the value. If current arguments can be derived from the search request, the system proceeds in step 14 to check in a stored conversation state 13 whether there are any conversational arguments. If yes, the system proceeds to perform a stage 1 search in step 15 using at least some of the current and conversational arguments. In step 16, the system checks whether the stage 1 search returned any results. If yes, the system returns the stage 1 results to the user in step 17. If step 15 detects that the stage 1 search did not return any results, the system proceeds to a stage 2 search in step 18 using only all of the current arguments. In step 19, the system checks whether the stage 2 search returned any results. If yes, the system returns the stage 2 results to the user 17. If step 19 detects that the stage 2 search did not return any results, the system proceeds to a stage 3 search in step 20 using no arguments. Any and all results from the stage 3 search are returned to the user in step 17. After the system returns results to the user, the method ends in step 21.

If step 12 finds current arguments but the check for conversational arguments in step 14 finds no conversational arguments, then the method proceeds directly to the stage 2 search in step 18.

If step 12 finds no current arguments, the method proceeds directly to step 20 to perform a stage 3 search without any arguments, regardless of whether the conversation state 13 has any conversational arguments.

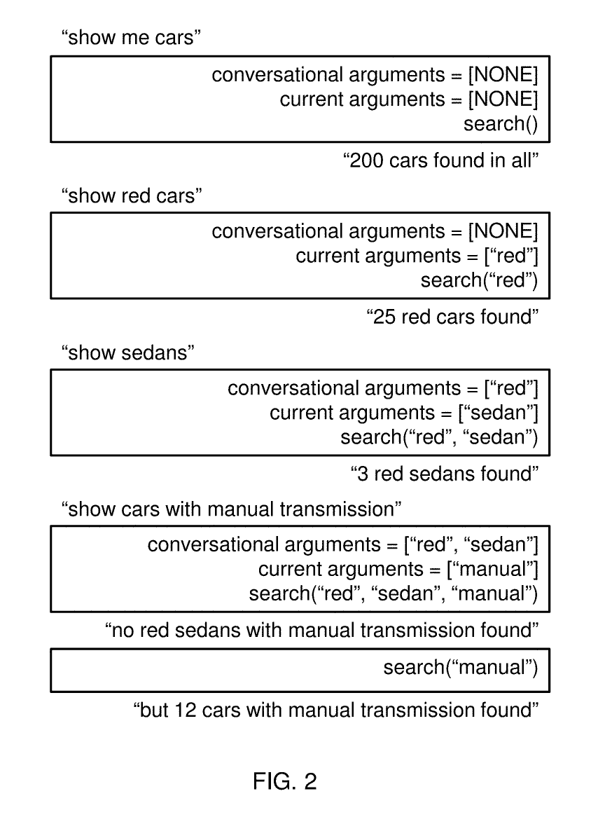

FIG. 2 shows a dialog between a user and a system, according to an embodiment, that performs filtered searches of a database of used car inventory. The dialog includes multiple rounds of search request/response in which a user specifies a search request, the system returns search results and responds to the user, and the current arguments in the search request are added to the conversation state for potential use in the next round of dialog. The searches are constructed from the user's natural language expressions, and the used car inventory includes a database record for each car, the records comprising fields for various attributes of cars such as color, body type, transmission type, make brand, and whether the car has a sunroof.

The dialog begins when a user makes a search request, “show me cars”. That results in a search query on the used car inventory database. The system has no conversational arguments and the search request specifies no current arguments. The term, “cars”, in this example, is not a search argument because the entire database is a database of cars, therefore the term, “cars”, has no filtering effect on search results. The system responds with a list of cars and says, “200 cars found in all”. Various embodiments respond to user requests with different combinations of visual and audio information. In the embodiments of FIG. 2, the system responds visually in a browser window with lists of cars, through which a user can scroll, and audibly speaks information about the number of results and search filter values used.

Next, the user makes a search request, “show red cars”. The system has no conversational arguments, but the search request specifies the current argument, “red”. The system performs a stage 2 search, responds with a list of cars, and says, “25 red cars found”.

Next, the user makes a search request, “show sedans”. The system has conversational argument, “red”, and the search request specifies the current argument, “sedan”. The system performs a stage 1 search with the current argument and the conversational argument, responds with a list of cars, and says, “3 red sedans found”.

Next, the user makes a search request, “show cars with manual transmission”. The system has conversational arguments, “red” and “sedan”, and the search request specifies the current argument “manual”. The system performs a stage 1 search with the current argument and the conversational arguments and says, “no red sedans with manual transmission found”. The system proceeds to perform a stage 2 search with just the current argument “manual”, responds with a list of cars, and says, “but 12 cars with manual transmission found”.

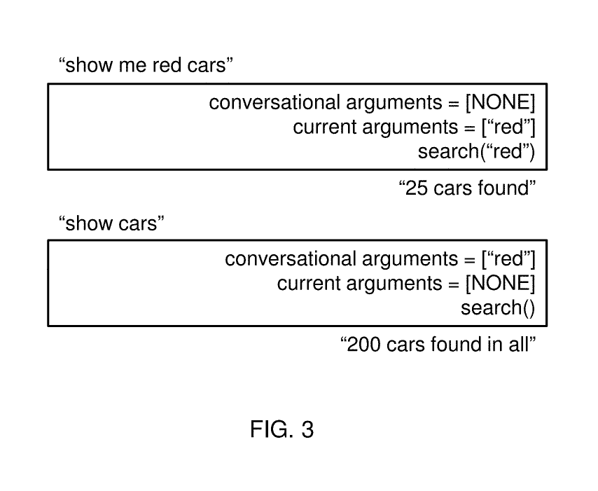

FIG. 3 shows a dialog between a user and a system according to an embodiment. The dialog begins when a user makes a search request, “show me red cars”. The system has no conversational arguments, but the search request specifies the current argument, “red”. The system performs a stage 2 search, responds with a list of cars, and says, “25 cars found”.

Next, the user makes a search request, “show cars”. Although the system has a conversational argument, “red”, since the search request specifies no current argument, the system directly performs a stage 3 search, responds with a list of cars, and says, “200 cars found in all”.

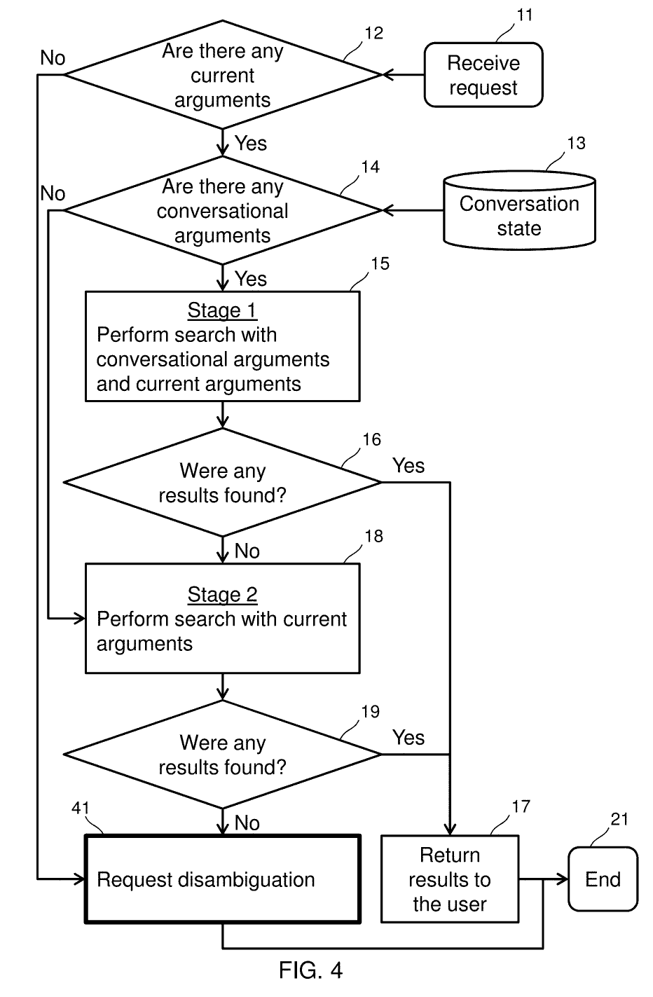

FIG. 4 shows a method of system operation according to an embodiment of the invention. The method is similar to the method shown in FIG. 1, but step 41 of FIG. 4 replaces step 20 of FIG. 1. However, if step 12 finds no current arguments, or if step 19 finds no stage 2 results, then the system proceeds to request the user to provide disambiguation at step 41. After the request for disambiguation, the method ends at step 21. Disambiguation is a process that comprises responding to a user search request with a request to the user to provide a particular type of additional information, followed by a state of expecting such information. For example, a user request to search for family cars is ambiguous because both vans and sedans are useful for families A system that performs disambiguation would respond to the user with a question, “Do you want vans or sedans”. Such a system enters a state of waiting for the user to respond with one choice or the other. Some such systems, if the user provides a next search request that is neither “vans” nor “sedans”, treats the new search request as a different search request without regard to conversational arguments.

Many types of requests for disambiguation are possible. Some embodiments say, “the search is indeterminate”. Some embodiments say, “no result, please try again”. Some embodiments suggest a follow-up search request, such as one with the conversational arguments but not the current arguments.

To suggest a follow-up query, some embodiments suggest a query that discards all arguments needed, starting from the least important, in order to find a result. Some embodiments restrict the discarding of arguments to conversational arguments and keep all current arguments. Some embodiments restrict the discarding of arguments to current arguments and keep all conversational arguments for the recommended follow-up search request. Some embodiments recommend the set of arguments for a follow-up search request that provides the smallest non-zero number of results.

Disambiguation is especially important when a user expects a specific result, such as a contact name Disambiguation is less important when a user has a preference for some results but is open to other search results, such as searching for a restaurant.

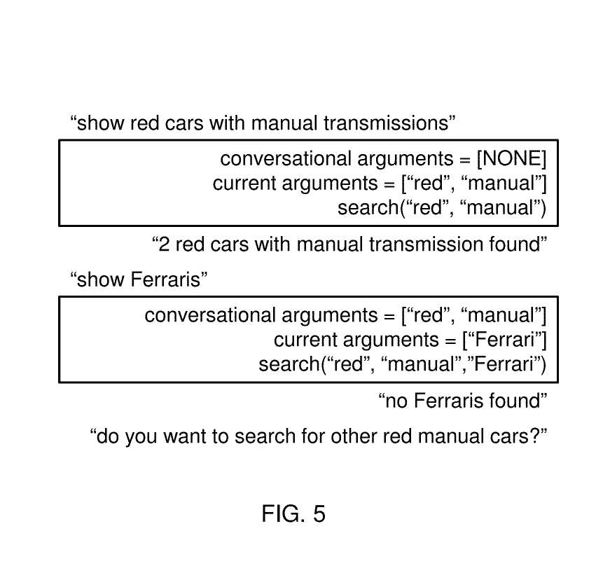

FIG. 5 shows a dialog between a user and a system according to an embodiment. The dialog begins when a user makes a search request, “show red cars with manual transmissions”. The system has no conversational arguments, but the search request specifies the current arguments, “red” and “manual”. The system performs a stage 2 search, and says, “2 red cars with manual transmission found.” Subsequently, the user requests “show Ferraris”. Conversational arguments include “red” and “manual”, and in step 15 the system searches for red manual Ferraris. Not finding any red manual Ferraris in step 16, the system searches only for Ferraris (the current argument) in step 18. Failing to find any Ferraris, the flow proceeds to step 41 for disambiguation and says, “no Ferraris found. do you want to search for other red manual cars?”

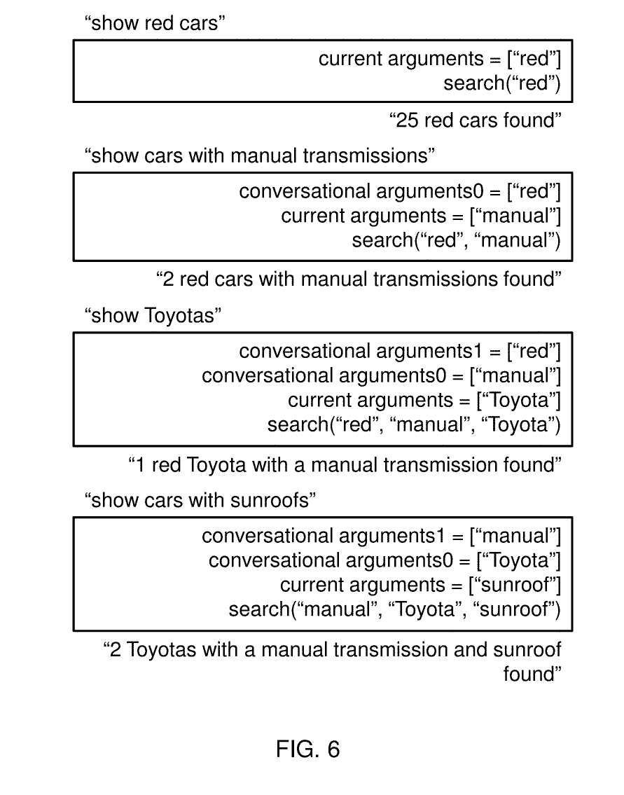

FIG. 6 shows a dialog between a user and a system that maintains a conversation state and uses conversational arguments from multiple entries of history, according to an embodiment of the invention.

The dialog begins when a user makes a search request, “show red cars”. The system performs a stage 2 search with the current argument, responds with a list of cars, and says, “25 red cars found”.

Next, the user makes a search request, “show cars with manual transmissions”. The system has a first most recent conversational argument 0, “red”, and the search request specifies the current argument “manual”. The system performs a stage 1 search with the current argument and most recent conversational argument (labelled conversational arguments0 in FIG. 6), responds with a list of cars, and says, “2 red cars with manual transmissions found”.

Next, the user makes a search request, “show Toyotas”. The system places the previous first most recent conversational argument 0 in a second most recent conversational argument 1 and places the previous current argument, “manual”, into the first most recent conversational argument 0. Since the search request specifies the current argument, “Toyota”, the system performs a stage 1 search with the current argument and both most recent conversational arguments (red, manual), responds with a list of cars, and says, “1 red Toyota with a manual transmission found”.

Next, the user makes a search request, “show cars with sunroofs”. Because the system of this embodiment maintains only two rounds of conversational arguments, the system discards the second most recent conversational argument, “red”. Next, the system places the previous first most recent conversational argument 0, “manual”, in the second most recent conversational argument 1, and places the previous current argument, “Toyota”, in the first most recent conversational argument 0. Since the search request specifies the current argument, “sunroof”, the system performs a stage 1 search with the current argument (sunroof) and both most recent conversational arguments (Toyota, manual), responds with a list of cars, and says, “2 Toyotas with a manual transmission and sunroof found”.

Some systems maintain more rounds of conversational arguments, but discard arguments older than a certain amount of time, such as 5 seconds, 30 seconds, or 5 minutes.

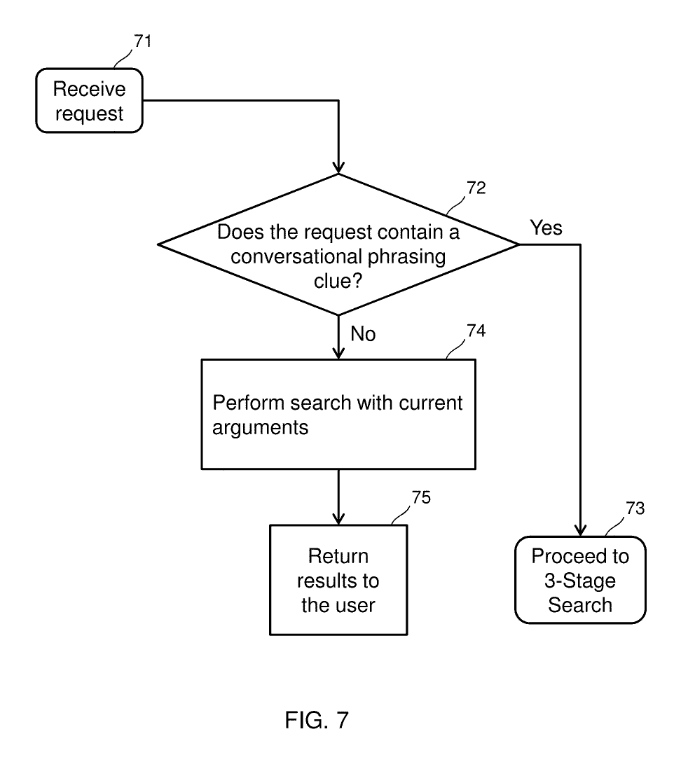

FIG. 7 shows a method of determining which arguments to use in a search query based on detecting the presence of a conversational phrasing clue, according to some embodiments. The method begins when a system receives a search request 71. The system parses the user utterance that causes the request to detect whether the utterance contains a conversational phrasing clue. The system checks whether the request contains a conversational phrasing clue in step 72. If it does then the system proceeds to the 3-stage search method 73 as shown in FIG. 1. If the search request does not contain a conversational phrasing clue then the system proceeds to perform a search with the current arguments 74 without using arguments from the conversational state even if there are such arguments. The system returns the search results to the user 75.

Some such embodiments will perform the search without any arguments if no current arguments are specified in the user's request.

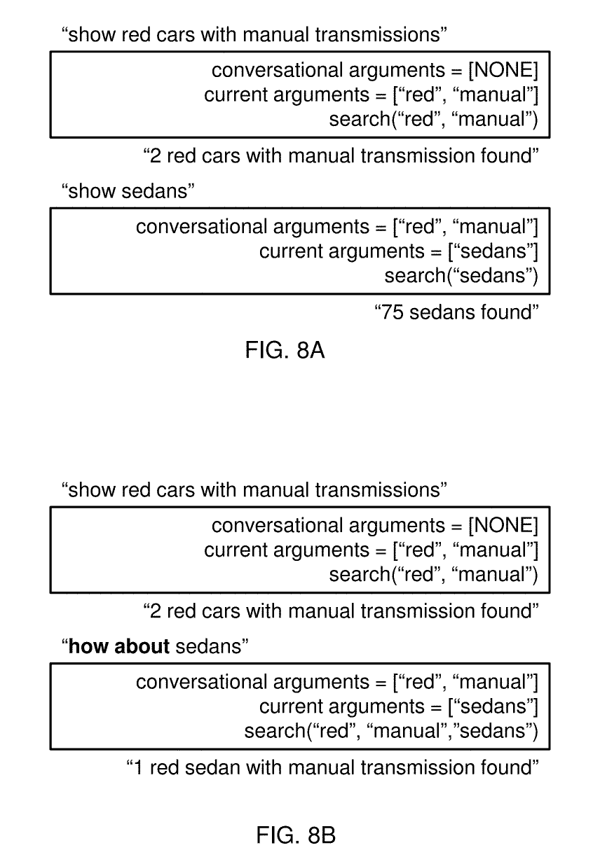

FIG. 8A shows a dialog between a user and a system that uses conversational phrasing clues to determine which arguments to use to filter a search request, according to an embodiment. FIG. 8A illustrates an example of a subsequent search request that does not include a conversational phrasing clue. The dialog proceeds according to the steps illustrated in FIG. 7 and begins when a user makes a search request, “show red cars with manual transmissions”. The search request has current arguments “red” and “manual”. The system performs an appropriate search. The user makes a subsequent search request, “show sedans”, which has no conversational phrasing clue. The system stores the arguments “red” and “manual” in conversation state, but in step 72 proceeds to step 74 and performs a search using only the current argument, “sedan”. The system responds with a list of cars and says, “75 sedans found”.

FIG. 8B shows a dialog between a user and a system that uses conversational phrasing clues to determine which arguments to use to filter a search request, according to an embodiment. FIG. 8B illustrates an example of a subsequent search request that includes a conversational phrasing clue. The dialog proceeds according to the steps illustrated in FIG. 7 and begins when a user makes a search request, “show red cars with manual transmissions”. The search request has current arguments “red” and “manual”. The system performs an appropriate search. The user makes a subsequent search request, “how about sedans”, which includes the conversational phrasing clue, “how about.” “How about” references conversation state from previous interactions. The system stores the arguments “red” and “manual” in conversation state, and in step 72 proceeds to step 73 that performs the steps of FIG. 1, which performs a search using the current argument, “sedan” and the conversational arguments, “red” and “manual”. The system returns a list of cars, and responds, “1 red sedan with manual transmission found”.

Some embodiments distinguish between natural language expressions that contain a search request and those that do not. For example, expressions like, “weather forecast”, “what's the weather”, and “show the weather” are interpreted as search requests. Expressions like, “text mom”, “stop”, and “what a beautiful sunset” are not interpreted as search requests. Some embodiments disregard expressions that are not interpreted as search requests and discard arguments, such as “mom”, from conversation state. Some embodiments keep arguments of expressions that are not search requests in order to use them in subsequent search requests such as, “text mom”, followed by, “show her number”.

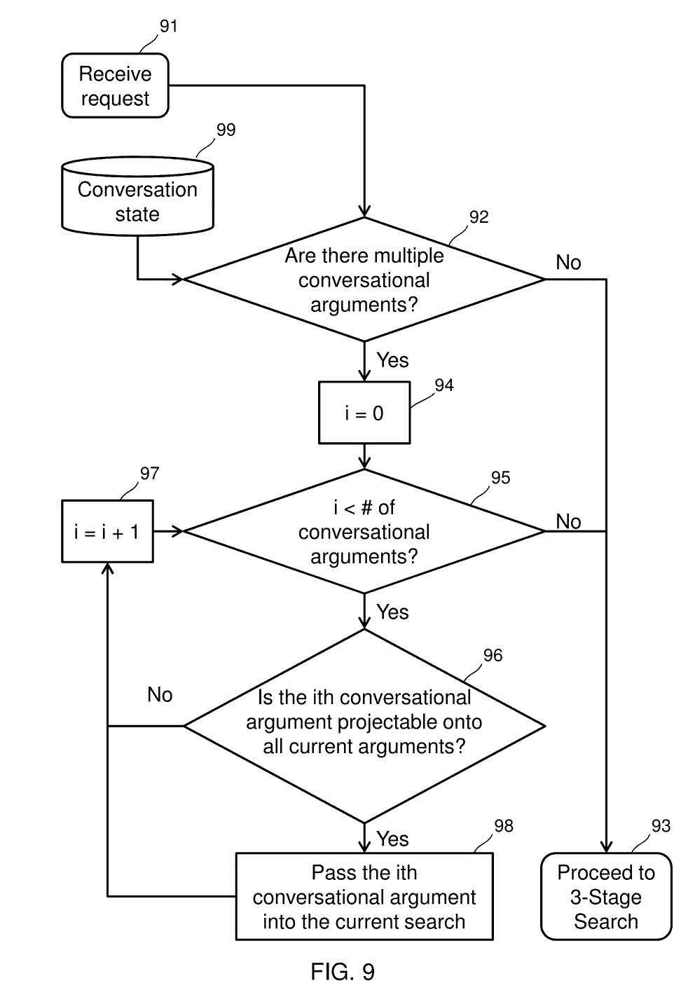

FIG. 9 shows a method of selecting conversational arguments to combine in a search query based on whether each is projectable onto all current arguments, according to some embodiments. The method begins when a system receives a search request 91. The system checks in step 92 to see whether there are multiple conversational arguments in the conversation state 99. If there are not, then the system proceeds to the 3-stage search method 93 as shown in FIG. 1. If the request does have multiple conversational arguments, the system proceeds through a loop, beginning by initializing index counter i=0 in step 94. If i has reached the index of the final conversational argument in step 95, the system proceeds to the 3-stage search method 93. If i has not reached the index of the final conversational argument in step 95, the system checks to see if the conversational argument of the current index i is projectable onto all current arguments in step 96. If not, the system disregards the conversational argument and proceeds to increment i by one in step 97 and return to step 95. If the conversational argument of the current index i is projectable onto all current arguments the system adds the conversational argument to the current combined search arguments in step 98 and proceeds to the increment step 97 to inspect the next conversational argument.

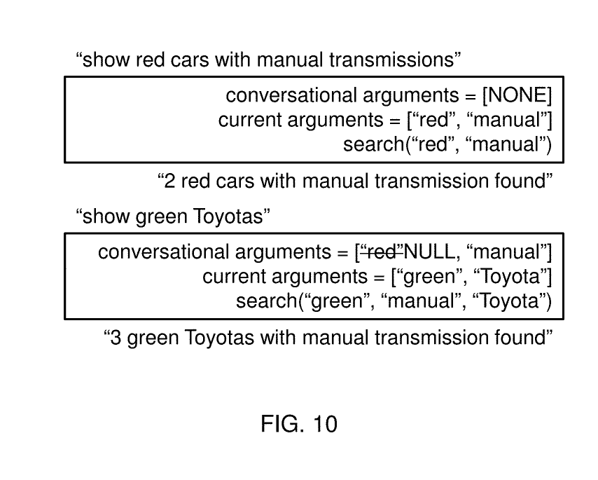

FIG. 10 shows a dialog between a user and a system according to an embodiment that selects conversational arguments for inclusion in a search filter based on whether each is projectable onto all current arguments. The dialog begins when a user makes a search request, “show red cars with manual transmissions”. The search request has current arguments “red” and “manual”. The system performs an appropriate search, gives a response “2 red cars with manual transmission found”, and stores “red” and “manual” as conversational arguments in the conversation state. The user makes a subsequent search request, “show green Toyotas”. The system checks to see whether each conversational argument is projectable onto both of the current arguments, “green” and “Toyota”. Conversational argument “red” is not projectable onto current argument, “green” because they are mutually exclusive. A car cannot be both red and green. Therefore, the system discards the conversational argument “red”. Since the conversational argument “manual” is projectable onto cars with current arguments “green” and “Toyota”, the system passes that conversational argument to the 3-stage search method of FIG. 1. The system performs a search with arguments “green”, “manual”, and “Toyota”, responds with a list of cars, and says, “3 green Toyotas with manual transmission found”.

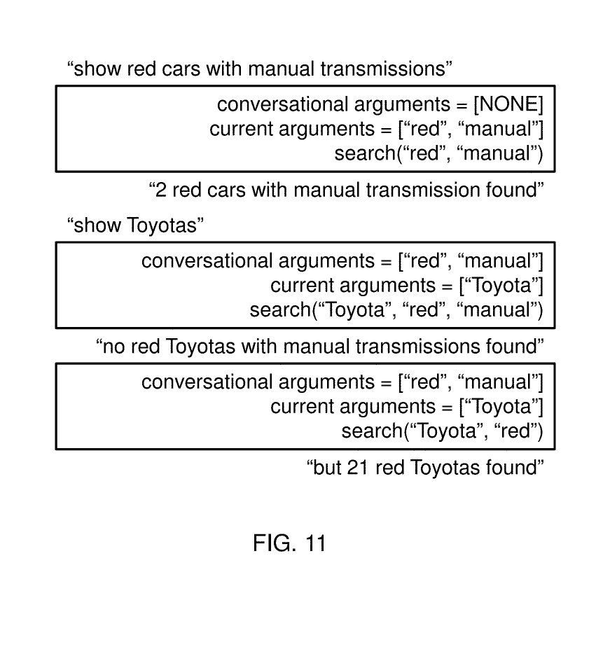

FIG. 11 shows a dialog between a user and a system according to an embodiment that automatically broadens its search by discarding arguments in order to provide a non-empty set of results. The dialog begins when a user makes a search request, “show red cars with manual transmissions”. The search request has current arguments “red” and “manual”. The system performs an appropriate search, gives a response “2 red cars with manual transmission found”, and stores “red” and “manual” as conversational arguments in the conversation state. The user makes a subsequent search request, “show Toyotas”. The system performs a search using current argument “Toyota” and conversational arguments “red” and “manual”. The search finds no results and so the system responds, “no red Toyotas with manual transmissions found”. However, the system proceeds to broaden the search by discarding the conversational argument, “manual”. The system performs a search, shows a list of cars, and responds, “but 21 red Toyotas found”. As a result, the user gets some results. It is important, for some embodiments, to provide the initial response that the search found no results matching the specified set of arguments before proceeding to give results for a broader search using a subset of arguments. Some examples of criteria for selecting which argument to discard are described below.

For some embodiments, searching requires a significant amount of time and responding takes a significant amount of time. For such embodiments, the latency due to the second search is, at least partially, hidden from the user because the system conducts the search approximately concurrently with presenting the response, and without waiting for further user input.

Some embodiments are able to perform multiple follow-up searches, either sequentially or in parallel, during the time of responding to the first search. Some such embodiments provide the most useful results by performing multiple follow-up searches with different combinations of arguments. If only one follow-up search finds any results, the system responds with that search result. If more than one follow-up search finds any results, the system must choose which set of results to provide. Various systems may provide the search results with the greatest number of results, the search results with the smallest number, the search results from the search with the most important arguments, among other criteria.

Some embodiments assign each argument an importance value that indicates the relative likelihood of the user's concern over the value of the argument. For example, an argument as to whether a car has 4 doors or 2 is more important for most users than an argument as to the color of the car. In some embodiments, system designers provide an ordered list of arguments in order of importance. The system uses the importance order of arguments to decide which to discard from the set of conversational arguments when automatically broadening searches to seek results. In some natural language embodiments, the grammar rules of the system indicate the order of importance.

Some embodiments broaden searches by discarding current arguments instead of or in addition to discarding conversational arguments. This is useful, for example, if a current argument isn't projectable onto any conversational arguments. Similar criteria are appropriate for discarding current arguments as conversational arguments.

A human mind can only remember a limited number of concepts at a time (e.g. 3 to 7). When a new concept is introduced, it replaces one of the other concepts. Thus, older concepts tend to be replaced with newer concepts. Based on this understanding, some embodiments discard arguments first from the oldest conversation state entries. Some embodiments assign a timestamp to search arguments in conversation state, and disregard them after a specific expiration period. Such arguments are, therefore, time-dependent. Some embodiments give different expiration periods to arguments according to their respective importance values.

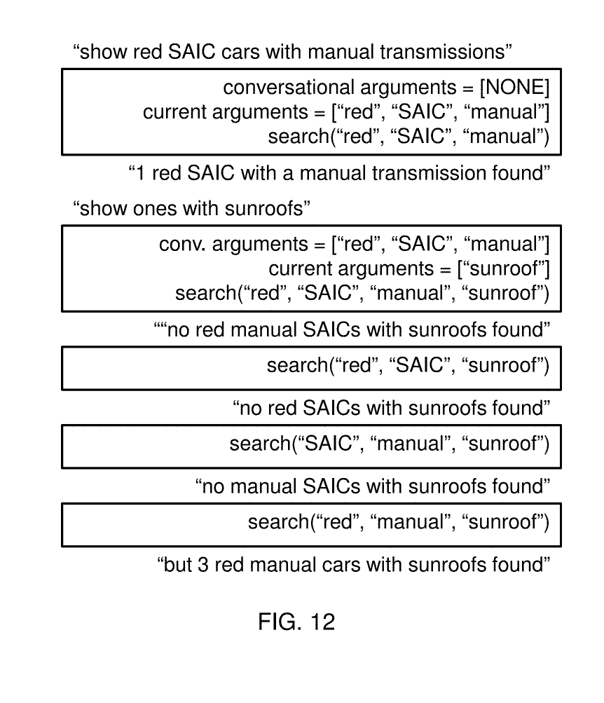

FIG. 12 shows a dialog between a user and a system according to an embodiment that automatically broadens its search by iteratively omitting different conversational arguments in order to provide a most-desirable set of results. Some such embodiments iterate through omitting one argument at a time. Some embodiments iterate through omitting different combinations of conversational arguments. Some embodiments report results to the user of each search with conversational arguments disregarded. Some embodiments only report the search result that is most desirable. Some embodiments consider a search result most desirable if it includes the largest number of results. Some embodiments consider a search result most desirable if it includes one or more of the most important arguments and disregards the less important arguments.

The dialog of FIG. 12 illustrates a user requesting information about availability of certain types of cars. The dialog begins when a user makes a search request, “show red SAIC cars with manual transmissions”. (SAIC cars are manufactured by The Shanghai Automotive Industry Corporation (SAIC), which is a prominent auto manufacturer in China). The search request has current arguments “red”, “SAIC”, and “manual”. The system performs an appropriate search, gives a response “1 red SAIC with manual transmission found”, and stores “red”, “SAIC”, and “manual” as conversational arguments in the conversation state. The user makes a subsequent search request, “show ones with sunroofs”. The system performs a search using current argument “sunroofs” and conversational arguments “red”, “SAIC”, and “manual”. The search finds no results. The system proceeds to perform a search omitting the argument, “manual”. That search finds no results, so the system responds, “no red SAICs with sunroofs found”. The system proceeds to search omitting the argument “red”. That search finds no results, so the system responds, “no manual SAICs with sunroofs found”. The system proceeds to search omitting the argument “SAIC”. The system finds 3 results, shows a list of cars, and responds, “3 red manual cars with sunroofs found”.

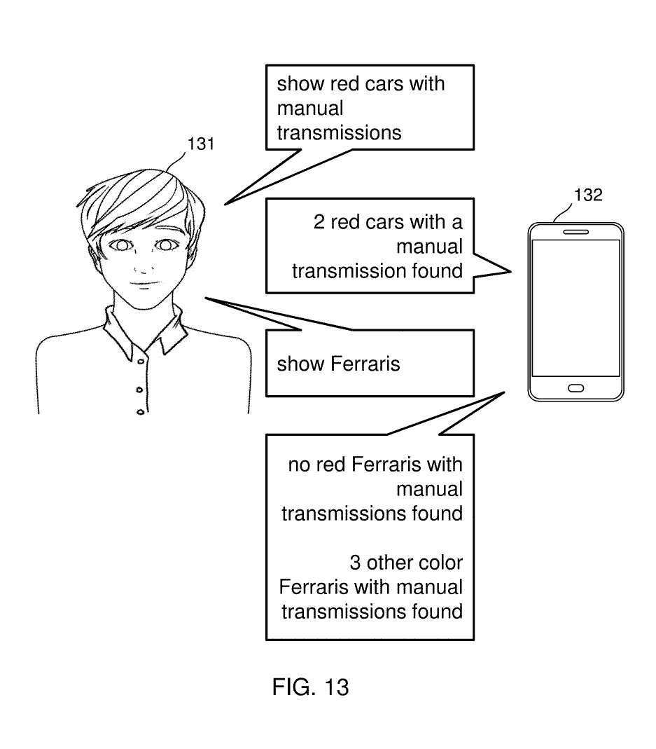

FIG. 13 shows an embodiment that comprises a user 131 in a dialog with a mobile phone 132.

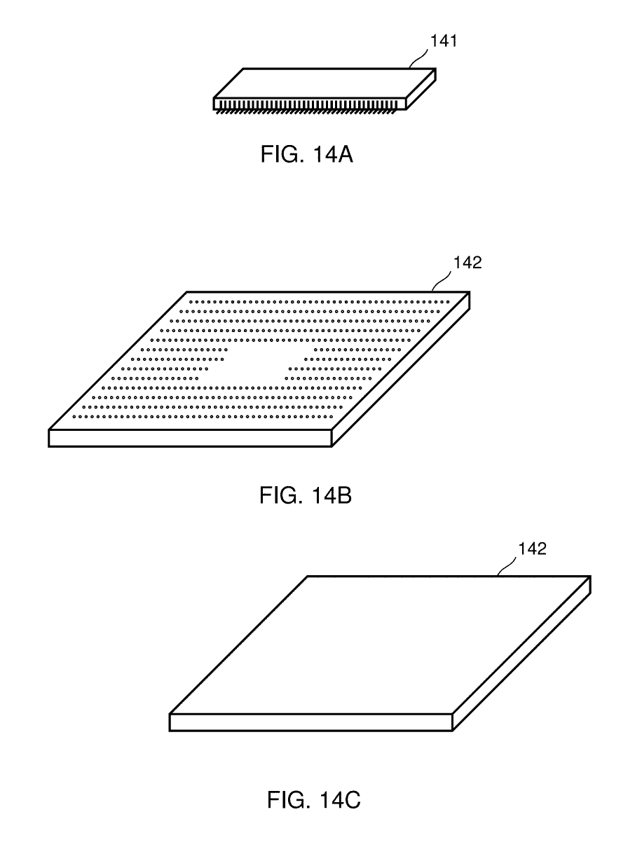

FIG. 14 shows some key components of mobile phone 132. FIG. 14A shows a Flash random access memory (RAM) chip 141 within the phone 132. The Flash RAM chip 141 is a non-transitory computer readable medium that stores code executable by a multi-processor system. FIG. 14B shows the solder-ball side of a system-on-chip package 142. FIG. 14C shows the top side of the system-on-chip package 142. The system-on-chip 142 and Flash RAM chip 141 connect on a printed circuit board within the phone, and through ribbon cables to the microphone, speaker, display, and modem. The system-on-chip 142 executes code stored in the Flash RAM chip 141, the code instructing the multiple processors of the system-on-chip 142 to perform methods as described herein.

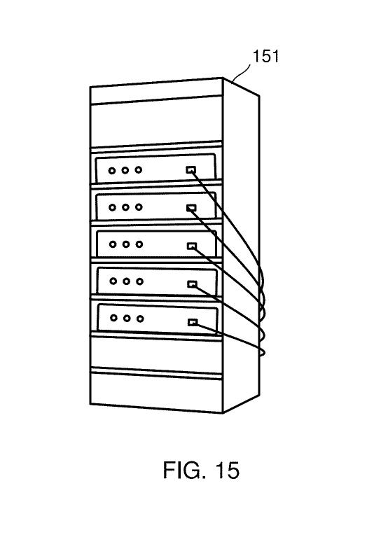

FIG. 15 shows a data center server 151. The mobile phone 132 uses its modem to communicate, through the wireless internet, to the server 151. The server further performs methods described herein. The server uses high-performance multi-core processors.

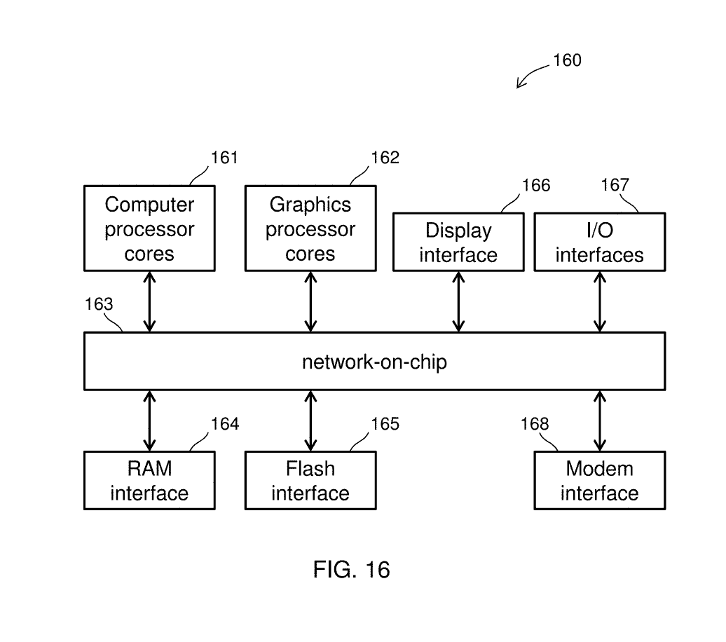

FIG. 16 shows a block diagram of a system-on-chip 160. It comprises a cluster of computer processor cores 161 and a cluster of graphics processor cores 162. The processor clusters are connect through a network-on-chip to a RAM interface 164, a Flash interface 165, a display interface 166, an I/O interface 167 for speakers and microphones, and a modem interface 168.

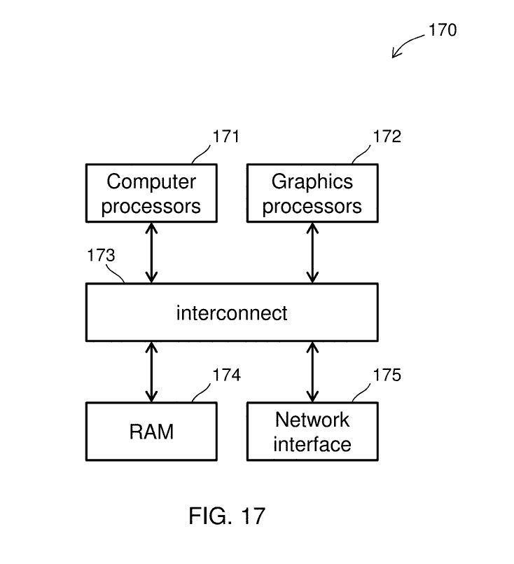

FIG. 17 shows a block diagram of a server processor 170. It comprises a multi-core computer processor 171 and a graphics processor 172, both connected through an interconnect 173 to a RAM 174 and a network interface 175.

What is claimed is:

1. A conversational search method comprising:
maintaining a conversation state including zero or more conversational arguments;
receiving a search request including zero or more current arguments;
responsive to the search request having a current argument and the conversation state including a conversational argument, performing a first search to seek results, using the current argument and the conversational argument to filter search results; and
responsive to the first search finding no results, automatically performing a second search to seek results, using the current argument without the conversational argument as search filters.

2. The method of claim 1, further comprising:
responsive to the second search finding no results, performing a third search to seek results, without using any arguments to filter search results.

3. The method of claim 1, further comprising:
responsive to the second search finding no results, asking a user to disambiguate the search.

4. The method of claim 1 wherein:
the conversation state comprises a history of arguments of multiple previous search requests; and
the conversational argument was used to filter search results less recently than the immediately previous search.

5. The method of claim 1, wherein performing the first search is further responsive to detecting a conversational phrasing clue in the received search request.

6. The method of claim 1, wherein the conversational argument is one of multiple conversational arguments stored in the conversation state.

7. The method of claim 1, further comprising:
determining which of multiple conversational arguments to use; and
responsive to a second conversational argument being not projectable, performing the search without the second conversational argument.

8. The method of claim 7, wherein the second conversational argument is not projectable because it is mutually exclusive with the current argument.

9. The method of claim 1, wherein the search request is by spoken speech.

10. The method of claim 1, further comprising:
parsing the search request, using a natural language interpreter, to extract the current argument.

11. A conversational search method comprising:
maintaining a conversation state enabled to hold at least two conversational arguments;
receiving a search request enabled to include at least one current argument;
responsive to the search request having a current argument and the conversation state holding a first conversational argument and a second conversational argument, performing a first search using the current argument, the first conversational argument, and the second conversational argument, to seek results; and
responsive to the first search finding no results, performing a second search to seek results, using the current argument and the first conversational argument, but not the second conversational argument.

12. The method of claim 11, wherein the first conversational argument has a higher importance than the second conversational argument.

13. The method of claim 11, wherein the second conversational argument is from a previous request than the first conversational argument.

14. The method of claim 11, wherein a value of the second conversational argument is time-dependent and past its expiration period.

15. A conversational search method comprising:
maintaining a conversation state enabled to hold at multiplicity of conversational arguments;
receiving a search request enabled to include at least one current argument; and
responsive to the conversation state holding more than a maximum number of conversational arguments, performing a first search to seek results, using the current argument and a first subset of conversational arguments, the number of conversational arguments in the subset being equal to the maximum number.

16. The method of claim 15, wherein the maximum number is 1.

17. The method of claim 15, wherein the maximum number is 2.

18. The method of claim 15, further comprising:
responsive to the first search finding no results, performing a second search to seek results, using a different second subset of conversational arguments, the number of conversational arguments being equal to the maximum number, and the current argument.

19. A non-transitory computer-readable medium storing code that, if executed by one or more processors would cause the one or more processors to:
maintain a conversation state including zero or more conversational arguments;
receive a search request including zero or more current arguments;
responsive to the search request having a current argument and the conversation state holding a conversational argument, perform a first search to seek results, using the current argument and the conversational argument; and
responsive to the first search finding no results, perform a second search to seek results, using the current argument without the conversational argument.

20. A conversational search method comprising:
receiving a search request that includes at least one argument value;
determining at least one current argument for each of the at least one argument values included in the search request;
performing a first search using a current argument of the at least one current arguments, a first conversational argument, and a second conversational argument to seek results, wherein the first conversation argument and the second conversation argument are retrieved from conversation state; and
responsive to the first search finding no results, performing a second search to seek results, using the current argument and the first conversational argument, but not the second conversational argument.
